(19) United States
(12) Patent Application Publication
(10) Pub. No.: US 2025/0173496 A1
(43) Pub. Date: May 29, 2025

(54) AUTO CALIBRATION METHOD AND SYSTEM

(71) Applicant: Samsung Electronics Co., Ltd., Suwon-si (KR)

(72) Inventors: Kyeyeop KIM, Suwon-si (KR); Sanghoon MYUNG, Suwon-si (KR); Jaehoon JEONG, Suwon-si (KR); Yunji CHOI, Suwon-si (KR); Songyi HAN, Suwon-si (KR)

(73) Assignee: Samsung Electronics Co., Ltd., Suwon-si (KR)

(21) Appl. No.: 18/948,987

(22) Filed: Nov. 15, 2024

(30) Foreign Application Priority Data
Nov. 29, 2023 (KR) 10-2023-0170035

(51) Int. Cl. G06F 30/398; G06F 17/13; G06F 17/17; G06F 111/10

(52) U.S. Cl. CPC G06F 30/398; G06F 17/13; G06F 17/17; G06F 2111/10

(57) ABSTRACT

An auto calibration method according to at least one example embodiment may include receiving at least one internal equation, input data associated with a semiconductor device design, and hardware data associated with the semiconductor device design, generating at least one approximation function based on the input data and the hardware data, determining at least one loss function based on the generated at least one approximation function, determining at least one parameter of the at least one approximation function and at least one parameter of the at least one internal equation such that a value of the loss function is 0, and selectively adjusting the semiconductor device design based on the determined at least one parameter of the at least one approximation function and the at least one parameter of the at least one internal equation.

### CROSS-REFERENCE TO RELATED APPLICATION

This U.S. non-provisional application is based on and claims the benefit of priority under 35 U.S.C. § 119 to Korean Patent Application No. 10-2023-0170035, filed on Nov. 29, 2023, in the Korean Intellectual Property Office, the disclosure of which is incorporated by reference herein in its entirety.

### BACKGROUND

Various example embodiments of the inventive concepts relate to an auto calibration method, apparatus, system, and/or non-transitory computer readable medium, etc. More particularly, one or more of the example embodiments of the inventive concepts relate to an auto calibration method, apparatus, system, and/or non-transitory computer readable medium capable of improving and/or optimizing at least one parameter of at least one internal equation without performing a technology computer aided design (TCAD) simulation.

A design simulator, such as a TCAD simulator, may be used to predict the characteristics of a manufactured semiconductor in the field, such as semiconductor manufacturing. To accurately predict the characteristics of a semiconductor design through a design simulator, output data indicating the characteristics of a semiconductor design may be observed by variably inputting input data indicating the layout, ion implantation, and the like, of the semiconductor design to the design simulator, and calibration of the semiconductor design for matching the output data to target output data may be performed. However, because the semiconductor manufacturing process is complicated, the number of influential factors to be considered for the simulation increases, thereby making it difficult to manually perform calibration. Although a deep learning-based calibration may be used to solve this difficulty, the deep learning-based calibration desires and/or requires a lot of TCAD data, thereby resulting in additional computational cost and expense.

### SUMMARY

Various example embodiments of the inventive concepts provide a method, apparatus, system, and/or non-transitory computer readable medium capable of directly solving at least one equation used in a technology computer aided design (TCAD) without performing a TCAD simulation, and improving and/or optimizing parameters related to at least one internal equation.

Various example embodiments of the inventive concepts also provide a method, apparatus, system, and/or non-transitory computer readable medium capable of simultaneously determining several solutions of at least one parameter related to at least one internal equation without performing a TCAD simulation.

According to at least one example embodiment of the inventive concepts, an auto calibration method is provided.

The method includes receiving at least one internal equation, input data associated with a semiconductor device design, and hardware data associated with the semiconductor device design, generating at least one approximation function based on the input data and the hardware data, determining at least one loss function based on the generated at least one approximation function, determining at least one parameter of the at least one approximation function and at least one parameter of the at least one internal equation such that a value of the loss function is 0, and selectively adjusting the semiconductor device design based on the determined at least one parameter of the at least one approximation function and the at least one parameter of the at least one internal equation.

According to at least one example embodiment of the inventive concepts, an auto calibration system is provided.

The system includes a non-transitory storage medium storing computer readable instructions and processing circuitry configured to execute the computer readable instructions to perform an auto calibration method.

According to at least one example embodiment of the inventive concepts, a non-transitory computer-readable storage medium is provided.

The non-transitory computer-readable storage medium stores computer readable instructions, which when executed by processing circuitry, causes the processing circuitry to, receive at least one internal equation, input data associated with a semiconductor device design, and hardware data associated with the semiconductor device design, generate at least one approximation function based on the input data and the hardware data, determine at least one loss function based on the generated at least one approximation function, determine at least one parameter of the at least one approximation function and at least one parameter of the at least one internal equation such that a value of the loss function is 0, and selectively adjust the semiconductor device design based on the determined at least one parameter of the at least one approximation function and the at least one parameter of the at least one internal equation.

According to at least one example embodiment of the inventive concepts, an auto calibration system is provided.

The system includes processing circuitry configured to receive at least one internal equation associated with a semiconductor device design and hardware data associated with the semiconductor device design as inputs, generate at least one approximation function based on the hardware data, generate at least one loss function based on the at least one approximation function, determine at least one parameter of the at least one approximation function and at least one parameter of the at least one internal equation such that the generated at least one loss function is 0, and selectively adjust the semiconductor device design based on the determined at least one parameter of the at least one approximation function and the at least one parameter of the at least one internal equation.

### BRIEF DESCRIPTION OF THE DRAWINGS

Various example embodiments of the inventive concepts will be more clearly understood from the following detailed description taken in conjunction with the accompanying drawings in which:

FIG. 1A is a flowchart schematically illustrating an auto calibration method according to at least one example embodiment of the inventive concepts;

FIGS. 1B, 1C, and 1D are flowcharts schematically illustrating operations of the auto calibration method of FIG. 1A, respectively, according to some example embodiments;

FIGS. 2A and 2B are flowcharts illustrating calibration methods according to comparative examples;

FIG. 3 is a flowchart illustrating a calibration method according to at least one example embodiment;

FIG. 4 is a block diagram illustrating an auto calibration system according to at least one example embodiment;

FIG. 5 is a block diagram illustrating an auto calibration system according to at least one example embodiment;

FIG. 6 is a flowchart illustrating functions used in an auto calibration method and system according to at least one example embodiment;

FIGS. 7A to 7C are flowcharts illustrating an auto calibration method according to at least one example embodiment;

FIG. 8 is a flowchart illustrating an auto calibration method according to at least one example embodiment;

FIG. 9 is a detailed flowchart illustrating an auto calibration method according to at least one example embodiment;

FIG. 10 is a detailed flowchart illustrating an auto calibration method according to at least one example embodiment;

FIG. 11 is a detailed flowchart illustrating an auto calibration method according to at least one example embodiment; and

FIG. 12 is a block diagram illustrating a computer system according to at least one example embodiment.

### DETAILED DESCRIPTION

Hereinafter, various example embodiments are described with reference to the accompanying drawings.

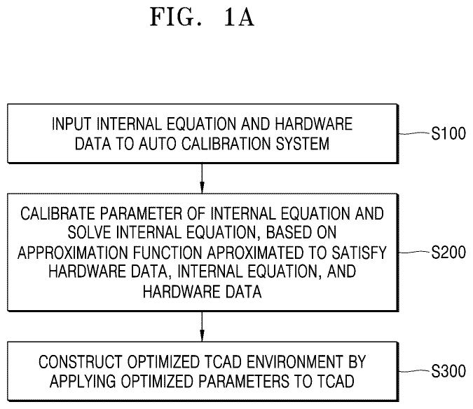

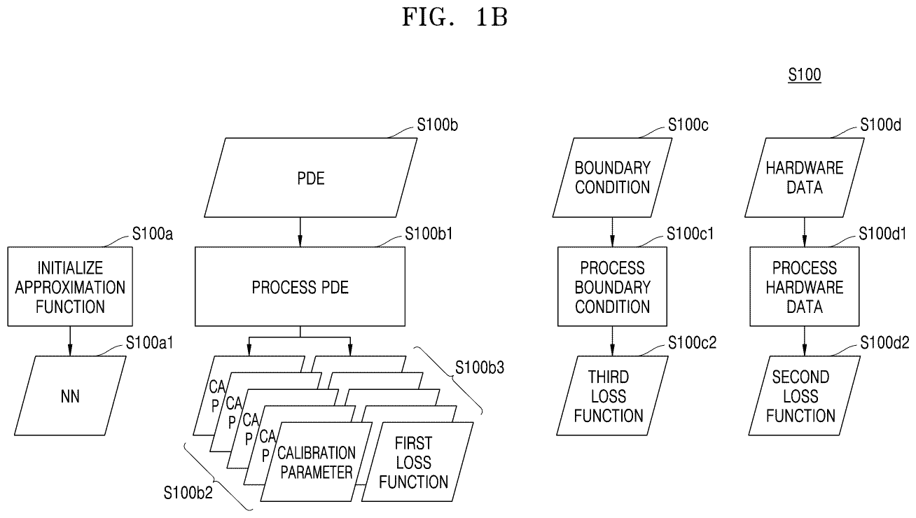

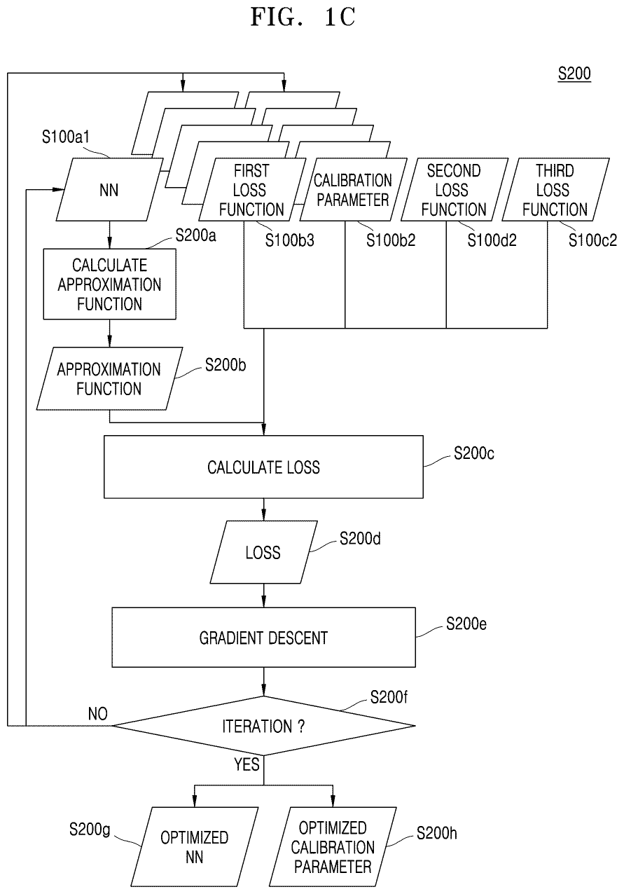

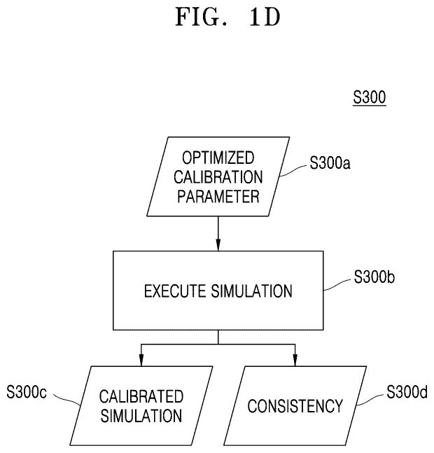

FIG. 1A is a flowchart schematically illustrating an auto calibration method according to at least one example embodiment of the inventive concepts. The auto calibration method of FIG. 1A may be performed by an auto calibration system to be described below, but is not limited thereto, and the auto calibration method may be performed on other comparable apparatuses and/or systems, etc. According to at least one example embodiment, the auto calibration method of FIG. 1A may be performed by at least one processor (e.g., processing circuitry) of the auto calibration system to be described below, but is not limited thereto. As shown in FIG. 1A, operations performed by the auto calibration system may include a plurality of operations S100, S200, and/or S300, etc., but is not limited thereto.

Referring to operation S100 of FIG. 1A, an internal equation and hardware data may be input to the auto calibration system.

The term “internal equation” may refer to any one of various equations used in a technology computer aided design (TCAD) simulator software. For example, the internal equation may be a partial differential equation (PDE), etc., but the example embodiments are not limited thereto.

The term “hardware data” may refer to result data obtained through an actual experiment and may be output when input data is input to a relevant equation associated with the internal equation, design requirements, user requirements, etc. Hardware data may refer to both input data and result data, or may refer to only the result data. For example, the term “input data” may include information about and/or related to the layout, ion implantation, and the like, of a semiconductor device design, a time condition, a depth condition, and the like, but is not limited thereto. As another example, the term “result data” may refer to information about and/or related to the electrical/structural characteristics of a semiconductor device and/or product, etc.

The term “calibration” may refer to adjustment of one or more parameters (e.g., variables, etc.) included in one or more internal equations such that a desired target value is output when input data is input to the one or more internal equations. Alternatively, or additionally, the term “calibration” may refer to adjustment of one or more parameters included in at least one approximation function such that a desired target value is output when input data is input to the at least one approximation function.

The term “relevant equation” may refer to at least one accurate equation represented as a result of solving an internal equation.

The term “deep neural network” may refer to at least one network model using at least one deep learning algorithm. For example, a deep neural network model, a deep neural network, a neural network, a machine learning network, an artificial intelligence network, and the like, may have the same meaning and may be used interchangeably.

Referring to operation S200 of FIG. 1A, the auto calibration system may calibrate at least one parameter of the at least one internal equation and solve the at least one internal equation, based on at least one approximation function approximated to satisfy the hardware data and the internal equation.

The auto calibration system may generate the approximation function which may satisfy the hardware data (and/or design requirements, user requirements, etc.). According to at least one example embodiment, the approximation function may be approximated through a neural network, etc. According to at least one example embodiment, the approximation function may be generated such that the approximation function uses input data as at least one variable and includes at least one deep learning parameter.

The auto calibration system may learn and/or determine the parameter of the internal equation and at least one parameter of the approximation function based on the input internal equation, the hardware data, and/or the approximation function, and may perform a calibration by adjusting, improving and/or optimizing the parameters. In addition, through the calibration, the internal equation may be solved and the semiconductor device design may be selectively adjusted, improved, and/or optimized based on the calibration and/or the solved internal equation, etc.

Referring to operation S300 of FIG. 1A, the auto calibration system may construct a selectively adjusted, improved, and/or optimized TCAD environment, or in other words, selectively adjust, improve, and/or optimize the semiconductor device design, by applying the parameters selectively adjusted, improved and/or optimized in operation S200 to a TCAD simulator.

In the auto calibration method according to at least one example embodiment, the parameter of the internal equation may be selectively adjusted, improved and/or optimized without using the TCAD simulator, e.g., without performing a TCAD simulation. The auto calibration method according to at least one example embodiment may be based on the internal equation including a PDE and the deep neural network. The auto calibration method according to at least one example embodiment of the inventive concepts may perform a calibration of the semiconductor device design by directly solving, using the deep neural network, a TCAD internal equation described as a PDE, and simultaneously adjusting, improving and/or optimizing a parameter of the PDE satisfying the hardware data. Because the auto calibration system according to at least one example embodiment of the inventive concepts is not based on data, generation of TCAD data for creating and/or generating the deep neural network is not required. According to at least one example embodiment of the inventive concepts, because the deep neural network is based on a PDE, a TCAD simulation for an update is not necessary. In addition, because adjustment, improvement, and/or optimization begins from a wide parameter area, global optimization (e.g., global adjustment, global improvement, etc.) of the semiconductor device design may be possible.

FIGS. 1B, 1C, and 1D are flowcharts schematically illustrating operations of the auto calibration method of FIG. 1A, respectively, according to some example embodiments.

FIG. 1B is a flowchart illustrating an example of operation S100 of the auto calibration method of FIG. 1A, but the example embodiments are not limited thereto.

Referring to operation S100, the internal equation associated with the semiconductor device design and the hardware data associated with the semiconductor device design may be input to the auto calibration system. Referring to FIG. 1B, an approximation function may be initialized in operation S100a. By doing this, a neural network function S100a1 of the approximation function may be generated.

In operation S100b, a PDE may be input. According to at least one example embodiment, the PDE may correspond to the internal equation. In operation S100b1, the input PDE may be processed, and as a result, calibration parameters S100b2 and first loss functions S100b3 using the PDE may be output.

In operation S100c, at least one boundary condition may be input. The boundary condition(s) may be associated with the PDE. In operation S100c1, the input boundary condition(s) may be processed to output a third loss function S100c2.

In operation S100d, the hardware data may be input. In operation S100d1, the hardware data may be processed to output a second loss function S100d2.

FIG. 1C is a flowchart illustrating an example of operation S200 of the auto calibration method of FIG. 1A according to at least one example embodiment.

Referring to operation S200, the internal equation may be solved by calibrating at least one parameter of the internal equation based on the approximation function approximated to satisfy the hardware data and/or the internal equation, etc.

A final loss value may be calculated and/or determined using the neural net function S100a1, the first loss functions S100b3, the calibration parameters S100b2, the second loss function S100d2, and the third loss function S100c2, which are output in operation S100. The neural net function S100a1 used herein may undergo approximation function calculation operation S200a and learn and/or determine an approximation function in operation S200b.

Loss value calculation operation S200c may be performed such that the sum of all loss values is 0. A loss value S200d obtained by performing loss value calculation operation S200c may be processed by applying a gradient descent algorithm to the loss value S200d in operation S200e, but the example embodiments are not limited thereto.

If this process is sufficiently iterated (yes in operation S200f), an adjusted, improved, and/or optimized neural net function S200g and an adjusted, improved, and/or optimized calibration parameter S200h may be output; otherwise, if this process is not sufficiently iterated (no in operation S200f), a loss function may be calculated and/or determined again by applying another calibration parameter to the loss function.

FIG. 1D is a flowchart illustrating an example of operation S300 of the auto calibration method of FIG. 1A according to at least one example embodiment.

Referring to operation S300, a selectively adjusted, improved, and/or optimized TCAD environment or in other words, selectively adjust, improve, and/or optimize the semiconductor device design, may be constructed by applying adjusted, improved, and/or optimized parameters to a TCAD. Referring to FIG. 1D, a simulation may be executed in operation S300b by using an adjusted, improved, and/or optimized calibration parameter S300a. This executed simulation may be a TCAD simulation, but is not limited thereto. As a result of executing the simulation in operation S300b, a calibration-applied simulation result S300c, e.g., a selectively adjusted, improved, and/or optimized semiconductor device design satisfying consistency S300d may be output.

More particular examples are described in detail below with reference to the drawings.

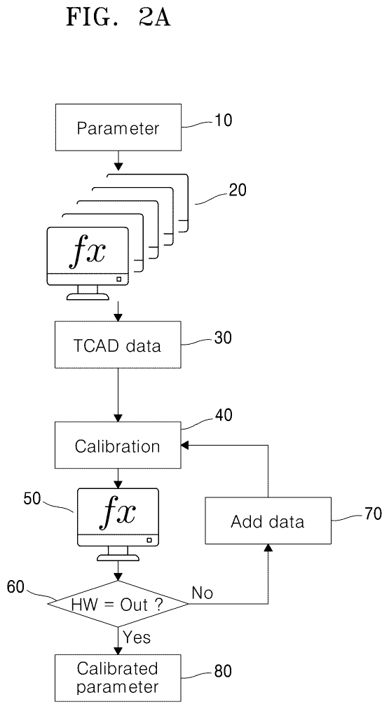

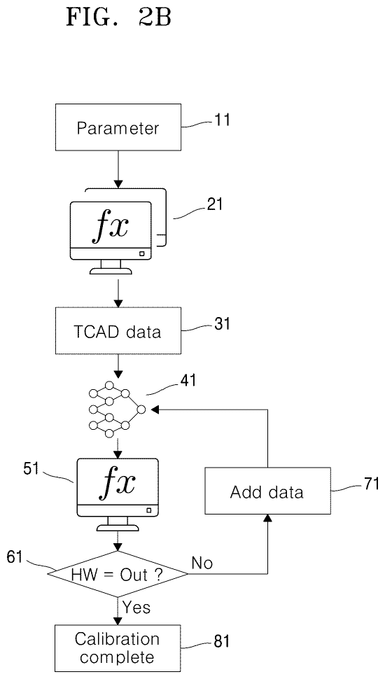

FIGS. 2A and 2B are flowcharts illustrating calibration methods according to comparative examples. Referring to FIGS. 2A and 2B, example embodiments of adjusting parameters by using TCAD data generated by a TCAD simulator are shown.

The TCAD simulators 20 and 21 shown in FIGS. 2A and 2B may be physical model-based computational simulators. The calibration methods shown in FIGS. 2A and 2B may be methods of predicting performance by approximating an experiment in a field, such as semiconductor manufacturing, etc., requiring a large experimental cost. In order for a semiconductor product to have desired electrical/structural characteristics, a designer of the semiconductor product may set desired and/or necessary parameters to obtain target output data including information about the desired electrical/structural characteristics through a design simulator, e.g., a TCAD simulator. For accurate approximation and performance prediction, a calibration between a simulation and an experiment is desired and/or essential. However, to enhance and/or improve the consistency of a simulation for a complicated manufacturing process, TCAD simulation time and TCAD simulator license cost increase, and the cost of an existing calibration accompanied with a TCAD simulation also increases. Referring to the comparative examples of FIGS. 2A and 2B, a TCAD simulator is used in a calibration process, TCAD data may be generated in a process of using a TCAD simulator, accumulation of pieces of TCAD data is a big burden for a memory and may not be efficient in terms of time and cost.

According to the comparative example of FIG. 2A, in which a parameter 10 is input to a TCAD simulator 20 is shown. Herein, the TCAD simulator 20 may perform a plurality of simulations to thereby obtain pieces of TCAD data 30.

The obtained pieces of TCAD data 30 are calibrated in operation 40 to adjust the parameters included in the TCAD simulator 20, and a TCAD simulation S0 is performed by a TCAD simulator 20 to check and/or determine whether the calibration has been accurately performed. In operation 60, an operator and/or user may determine whether an output value Out output through the TCAD simulation S0 matches hardware data HW. If the output value Out output through the TCAD simulation S0 matches the hardware data HW (yes in operation 60), a calibrated parameter is output in operation 80. Otherwise, if the output value Out output through the TCAD simulation S0 does not match the hardware data HW (no in operation 60), the operator and/or user may add data in operation 70 to proceed to operation 40 to perform a calibration again, and this process may be iterated until finding out and/or determining a parameter value by which an output value which matches the hardware data HW is obtained.

Referring to FIG. 2A, a plurality of pieces of TCAD data may be accumulated during a plurality of TCAD simulations, etc.

According to the comparative example of FIG. 2B, a parameter 11 is input to a TCAD simulator 21 is shown, but is not limited thereto. Herein, the TCAD simulator 21 may perform a plurality of simulations of the semiconductor device design to thereby obtain pieces of TCAD data 31 associated with and/or corresponding to the semiconductor device design, etc.

The obtained pieces of TCAD data 31 are input to a deep learning network model 41 to learn, adjust, determine, etc., one or more parameters, and a TCAD simulation S1 may be performed by a TCAD simulator to determine the accuracy of the learning result data. A user and/or operator may determine in operation 61 whether an output value Out output through the TCAD simulation S1 matches the hardware data HW. If the output value Out output through the TCAD simulation S1 matches the hardware data HW (yes in operation 61), a calibrated parameter is output in operation 81. Otherwise, if the output value Out output through the TCAD simulation S1 does not match the hardware data HW (no in operation 61), data may be added in operation 71 to proceed to operation 41 to train the deep learning network model 41 again, and this process may be iterated until finding a parameter value by which an output value matched to the hardware data HW is obtained.

Referring to FIG. 2B, a plurality of pieces of TCAD data may be accumulated during a plurality of TCAD simulations of the semiconductor device design.

Hereinafter, when using at least one example embodiment of the auto calibration methods described below, a TCAD calibration may be performed without performing and/or using a TCAD simulation (e.g., without performing a TCAD simulation and/or without using a TCAD simulator, etc.), thereby enabling more efficient processing in terms of time, a reduction in cost, etc.

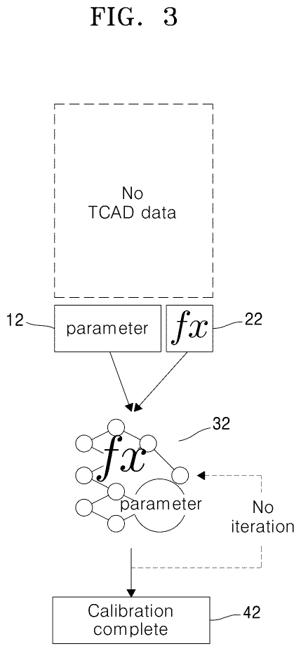

FIG. 3 is a flowchart illustrating a calibration method according to at least one example embodiment. Referring to FIG. 3, a TCAD simulator is not used, and accordingly, the TCAD data that is an output result of performing a simulation of the semiconductor device design using the TCAD simulator does not exist either.

Referring to FIG. 3, at least one parameter 12 and an internal equation 22 in a TCAD simulator may be input to an auto calibration system 32 and learned and/or determined. The auto calibration system 32 may receive the internal equation 22, the parameter(s) 12, and/or hardware data (not shown) and complete a calibration in operation 42 at once by using a deep learning network to learn and/or determine equations related to the received information. The auto calibration system 32 according to at least one example embodiment of the inventive concepts my complete the calibration at once without iterating an output result (e.g., without performing any additional iterations). Referring to the at least one example embodiment of FIG. 3, because at least one parameter may be adjusted, improved, and/or optimized even without using a TCAD simulator and TCAD data unlike the comparative examples of FIGS. 2A and 2B, a TCAD license cost may be reduced, and because the adjustment, improvement, and/or optimization is performed even without performing a TCAD simulation, the at least one example embodiment of FIG. 3 may also be economical in terms of time, may reduce the computing resources consumed, etc. An auto calibration system, apparatus, non-transitory computer readable medium, and an auto calibration method are particularly described below.

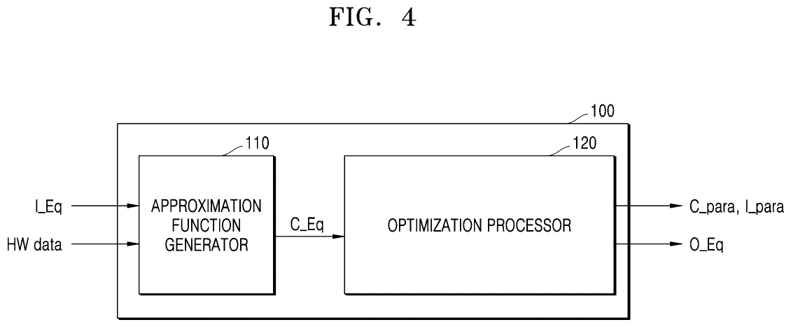

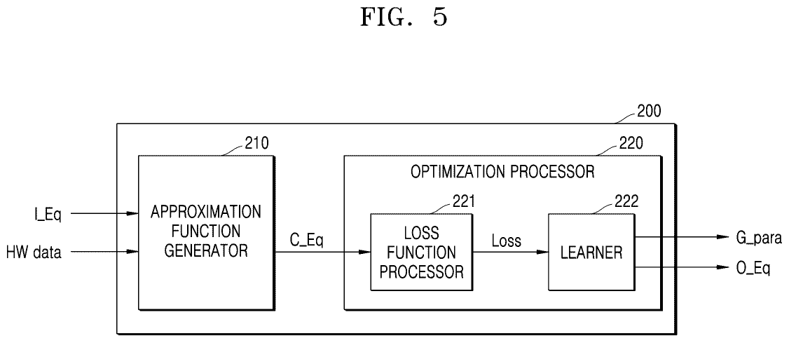

FIG. 4 is a block diagram illustrating an auto calibration system 100 according to at least one example embodiment. FIG. 5 is a block diagram illustrating an auto calibration system 200 according to at least one example embodiment.

Referring to FIG. 4, the auto calibration system 100 may include an approximation function generator 110 and/or an optimization processor 120, etc., but the example embodiments are not limited thereto, and for example, the auto calibration system 100 may include a greater or lesser number of constituent components. According to some example embodiments, one or more of the approximation function generator 110, the optimization processor 120, etc., may be implemented as processing circuitry. Processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The approximation function generator 110 may receive an internal equation I_Eq and/or hardware data HW data, etc., as inputs, but is not limited thereto. Herein, the internal equation I_Eq may be any one of a plurality of equations included in a TCAD simulator.

According to at least one example embodiment, the internal equation I_Eq may be a PDE used to calculate and/or determine result data in an environment associated with and/or corresponding to a desired TCAD design (e.g., a semiconductor device design, etc.) using the auto calibration system 100 according to at least one example embodiment of the inventive concepts. According to at least one example embodiment, the hardware data HW data may be output data obtained when input data is actually input to an equation associated with the internal equation I_Eq in an environment using the auto calibration system 100 according to at least one example embodiment of the inventive concepts or when an experiment associated with and/or corresponding to a desired TCAD design and/or an actual semiconductor device is actually performed using the input data.

According to at least one example embodiment, the approximation function generator 110 may generate an approximation function Ĉ _Eq capable of deriving the hardware data HW data based on the hardware data HW data. According to at least one example embodiment of the inventive concepts, the approximation function generator 110 may generate the approximation function Ĉ _Eq capable of outputting hardware data corresponding to input data based on pieces of input data and pieces of hardware data corresponding to the pieces of input data.

According to at least one example embodiment, the approximation function generator 110 may include at least one neural network model. The approximation function generator 110 may generate the approximation function Ĉ _Eq satisfying (e.g., matching, fulfilling, etc.) the hardware data HW data based on the neural network model. The approximation function generator 110 is not limited to the neural network model and may include various deep learning network models, artificial intelligence models, etc.

The optimization processor 120 may adjust, improve, and/or optimize a parameter C_para included in the approximation function Ĉ _Eq output from the approximation function generator 110. In addition, the optimization processor 120 may adjust, improve, and/or optimize a parameter I_para included in the internal equation I_Eq input to the approximation function generator 110.

The optimization processor 120 may adjust, improve, and/or optimize and output a relevant equation O_eq that is a result of solving and/or calculating, determining, etc., the internal equation I_Eq input to the approximation function generator 110, the parameter I_para included in the internal equation I_Eq, and the parameter C_para included in the approximation function Ĉ _Eq.

Referring to FIG. 5, the auto calibration system 200 may include an approximation function generator 210 and/or an optimization processor 220, etc. Because the approximation function generator 210 of FIG. 5 may correspond to the approximation function generator 110 of FIG. 4, the description made with reference to FIG. 4 is not repeated herein.

The optimization processor 220 may include a loss function processor 221 and/or a learner 222, etc., but is not limited thereto. The loss function processor 221 may calculate and/or determine a loss function Loss through a difference value between the approximation function Ĉ _Eq input to the optimization processor 220 and pieces of information input to the auto calibration system 200. According to some example embodiments, one or more of the approximation function generator 210, the optimization processor 220, the loss function processor 221, the learner 222, etc., may be implemented as processing circuitry. Processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The term “loss function” may refer to a function that represents a difference value between an approximation function and existing pieces of data. According to at least one example embodiment, a loss function may be a function of obtaining a mean value (e.g., average value) by substituting an approximation function into an internal equation and summing all difference values. According to another example embodiment, a loss function may be a function of obtaining a mean value by substituting an approximation function into hardware data and summing all difference values. However, the example embodiments of calculating and/or determining a loss function are not limited thereto and may be widely analyzed as a function of deriving a difference value between an approximation function approximated through a neural network and existing given data.

According to at least one example embodiment, the loss function processor 221 may calculate and/or determine a first loss function by calculating and/or determining the difference between the approximation function Ĉ _Eq input to the optimization processor 220 and the internal equation I_Eq input to the approximation function generator 210. According to at least one example embodiment, the loss function processor 221 may calculate and/or determine a second loss function by calculating and/or determining the difference between the approximation function Ĉ _Eq input to the optimization processor 220 and the hardware data HW data. According to at least one example embodiment, the loss function processor 221 may calculate and/or determine a third loss function by calculating and/or determining the difference between the approximation function Ĉ _Eq input to the optimization processor 220 and at least one boundary condition which the internal equation I_Eq has.

The loss function processor 221 may transmit the first loss function, the second loss function, and/or the third loss function to the learner 222. According to at least one example embodiment, at least one of the first loss function, the second loss function, and the third loss function output from the loss function processor 221 may be a function related to at least one parameter of the internal equation I_Eq and/or at least one parameter of the approximation function Ĉ _Eq.

The learner 222 may learn and/or determine both the parameter(s) of the internal equation I_Eq and the parameter(s) of the approximation function Ĉ _Eq such that the sum of the first loss function, the second loss function, and the third loss function input from the loss function processor 221 is 0. The learner 222 may simultaneously find out, calculate, and/or determine several solutions of the parameter(s) of the internal equation I_Eq. The learner 222 may calibrate the parameter(s) of the internal equation I_Eq and the parameter(s) of the approximation function Ĉ _Eq based on a gradient descent algorithm. According to at least one example embodiment, the learner 222 may include a deep learning model. The learner 222 may learn, calculate, and/or determine the parameter(s) of the internal equation I_Eq and the parameter(s) of the approximation function Ĉ _Eq based on the deep learning model.

The auto calibration systems 100 and 200 according to at least one example embodiment of the inventive concepts may perform a calibration of a physical model-based design and/or simulation by directly using an internal equation and a deep learning network.

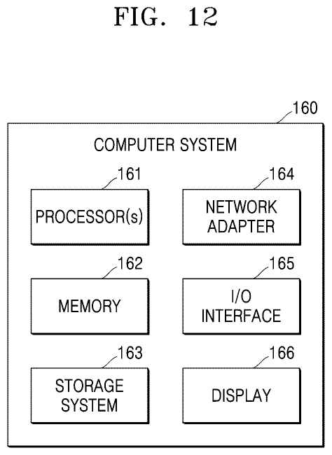

The auto calibration systems 100 and 200 according to at least one example embodiment of the inventive concepts may be applied to all physical model-based designs and/or simulations, e.g., a TCAD device, a TCAD process, a TCAD quantum, an electronic computer aided design (ECAD), and the like. An auto calibration system according to at least one example embodiment of the inventive concepts may be applied to all simulation fields and/or variables desiring and/or requiring a calibration. In addition, global optimization (e.g., global adjustment, etc.) may be performed by finding out, calculating, and/or determining a plurality of solutions at once. In addition, the auto calibration system according to at least one example embodiment of the inventive concepts may be applied to a field, such as machine learning-based physical model emulation, etc. The auto calibration system 100 or 200 of FIG. 4 or 5 may be included in a computing system (e.g., a computer system 160 of FIG. 12), but the example embodiments are not limited thereto.

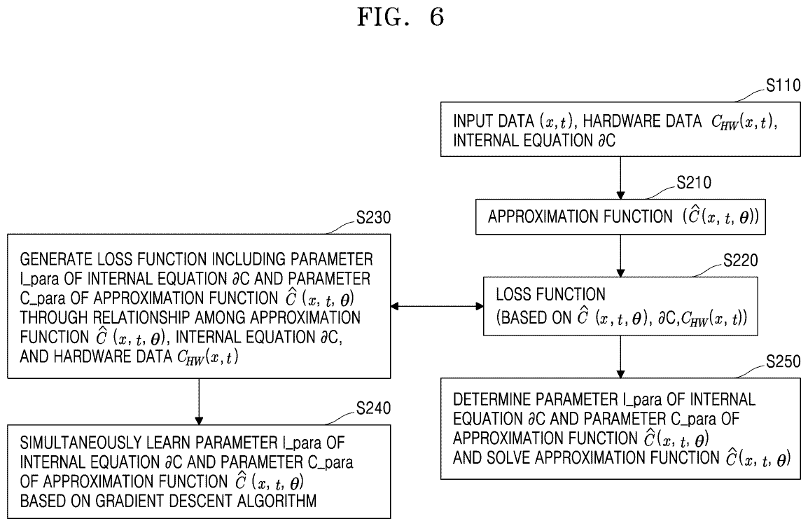

FIG. 6 is a flowchart illustrating functions used in an auto calibration method and system according to at least one example embodiment.

Referring to operation S110 of FIG. 6, input data (x, t), hardware data C_{HW}(x, t), and an internal equation ∂C may be input to the auto calibration system. According to at least one example embodiment, the input data (x, t) may be data related to depth x and time t, but the example embodiments are not limited thereto. According to at least one example embodiment, the hardware data C_{HW}(x, t) may be result data of an actual experiment using the depth x and the time t that are the input data (x, t). The internal equation ∂C may be a PDE of Ĉ(x, t) that is an equation for deriving the hardware data C_{HW}(x, t). According to at least one example embodiment, the functions disclosed in operation S110 of FIG. 6 may be the functions used in operation S100 of FIG. 1.

Referring to operation S210 of FIG. 6, an approximation function Ĉ(x, t, θ) may be generated based on the input data (x, t) and the hardware data C_{HW}(x, t). The approximation function Ĉ(x, t, θ) may be generated by a neural network model, but is not limited thereto. The approximation function Ĉ(x, t, θ) may be generated as a function in a range satisfying the input data (x, t) and the hardware data C_{HW}(x, t) and may include at least one parameter θ of the approximation function (x, t, θ).

Referring to operation S220 of FIG. 6, a loss function may be generated based on the approximation function Ĉ(x, t, θ).

Referring to operation S230 of FIG. 6, the loss function may be generated by comparing the approximation function Ĉ(x, t, θ) generated in operation S210 to the internal equation ∂C and the hardware data C_{HW}(x, t) input in operation S110. According to at least one example embodiment, the loss function may be calculated and/or determined by substituting the approximation function Ĉ(x, t, θ) into the internal equation d C and/or substituting the approximation function Ĉ(x, t, θ) into the hardware data C_{HW}(x, t) and the input data (x, t). According to at least one example embodiment, the loss function including the parameter(s) I_para of the internal equation ∂C and the parameter(s) C_para of the approximation function Ĉ(x, t, θ) may be generated through a relationship among the approximation function Ĉ(x, t, θ), the internal equation ∂C, and the hardware data C_{HW}(x, t).

Referring to operation S240 of FIG. 6, the parameter(s) I_para of the internal equation ∂C and the parameter(s) C_para (θ) of the approximation function Ĉ(x, t, θ) may be simultaneously learned, calculated, and/or determined based on a gradient descent algorithm, but is not limited thereto. According to at least one example embodiment, each parameter may be learned based on the gradient descent algorithm such that the loss function is 0.

Referring to operation S250 of FIG. 6, the parameter(s) I_para of the internal equation ∂C and the parameter(s) C_para of the approximation function Ĉ(x, t, θ), which are a learning result of operation S240, may be adjusted, improved, and/or optimized and determined, and the approximation function Ĉ(x, t, θ) may be solved.

According to at least one example embodiment, the functions and the parameters disclosed in operations S210, S220, S230, S240, and S250 of FIG. 6 may be the functions and the parameters used in operation S200 of FIG. 2, but are not limited thereto.

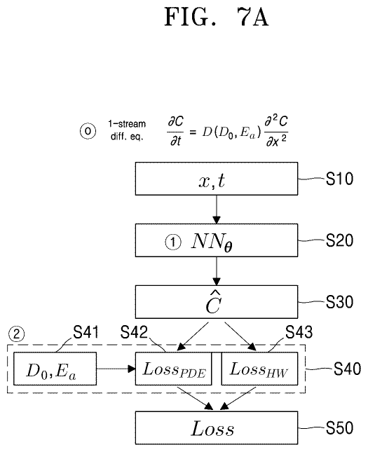

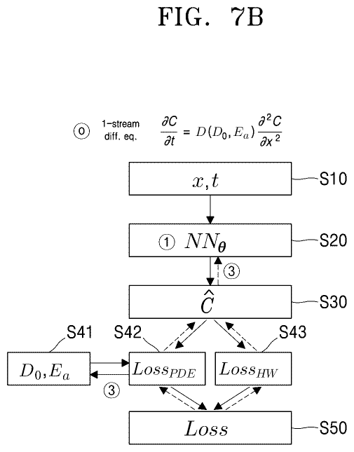

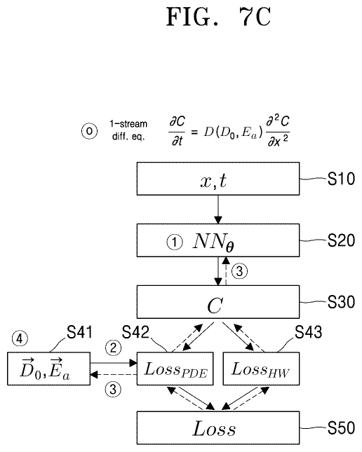

FIGS. 7A to 7C are flowcharts illustrating an auto calibration method according to at least one example embodiment.

Referring to FIG. 7A, an example internal equation is disclosed in \textcircled{0}, however the example embodiments are not limited thereto, and other equations may be used for the auto calibration method. The internal equation may be a PDE derived by a TCAD simulator, etc.

The internal equation of FIG. 7A is reproduced in Equation 1 below, but the example embodiments are not limited thereto.

$$\frac{\partial C}{\partial t} = D ( {D}_{0} , {E}_{a} ) \frac{{\partial }^{2} C}{\partial {x}^{2}} , x ∈ Ω , t ∈ [ 0 , T ] \qquad [ Equation 1 ]$$

In Equation 1, C denotes a dopant concentration, t denotes time, D₀, E_{α} denote first and second parameters of the internal equation, D(D₀, E_{α}) denotes an internal parameter function based on the first and second parameters D₀, E_{α} of the internal equation, and x denotes depth, but the example embodiments are not limited thereto. A range of the depth x and a range of the time t may be determined as a condition.

Referring to FIG. 7A, (x, t) may be input to an auto calibration system as input data in operation S10. In addition, hardware data corresponding to the input data (x, t) may be input. Therefore, a neural network approximating the dopant concentration C may be defined from the depth and the time (x, t) that are input data, in operation S20. The neural network may approximate any function (by a universal approximation theorem) and a solution of a PDE is unique if an initial condition and a boundary condition are determined. Examples of the hardware data according to at least one example embodiment may be represented as follows, but are not limited thereto.

$$C ( x , 0 ) = {C}_{HW , as implant} , x ∈ Ω , t = 0 \qquad [ Equation 2 ]$$

$$C ( x , T ) = {C}_{HW , after diffusion} , x ∈ Ω , t = T \qquad [ Equation 3 ]$$

Equation 2 may indicate hardware data when t is 0 at the depth x, e.g., in the initial condition. Equation 3 may indicate hardware data corresponding to a result when t is the maximum value T at the depth x, e.g., when an experiment is completed.

$${NN}_{θ} ( x , t ) ↦ \hat{C} \qquad [ Equation 4 ]$$

Equation 4 represents an approximation function NN_{θ}(x, t) approximated by considering the hardware data obtained by Equations 2 and 3 and a dopant concentration Ĉ calculated and/or determined using the approximation function NN_{θ}(x, t) in operation S30, but the example embodiments are not limited thereto.

Once the approximation function Ĉ is generated, Ĉ approximated by the neural network may be compared to the internal equation and the hardware data to define and calculate and/or determine a loss function. According to at least one example embodiment, the loss function may be defined as follows, but the example embodiments are not limited thereto.

$${Loss}_{PDE} ( \hat{C} ) = \frac{1}{{N}_{PDE}} {\sum }_{i = 1}^{{N}_{PDE}} ‖ \frac{\partial \hat{C}}{\partial t} - D ( {D}_{0} , {E}_{a} ) \frac{{\partial }^{2} C}{\partial {x}^{2}} ‖ \qquad [ Equation 5 ]$$

Referring to Equation 5, one example (operation S42) of substituting the approximation function Ĉ approximated by the neural network into Equation 1 that is the internal equation, and calculating and/or determining, as a first loss function Loss_{PDE}(Ĉ), a difference value of a corresponding equation such that a result of substituting the approximation function Ĉ into Equation 1 is satisfied. According to at least one example embodiment, the first loss function Loss_{PDE} may indicate how much the first and second parameters D₀, E_{α} of the internal equation deviate from the approximation function Loss_{PDE}

$${Loss}_{HW} ( \hat{C} ) = \frac{1}{{N}_{HW}} {\sum }_{i = 1}^{{N}_{HW}} ‖ \hat{C} - {C}_{HW} ‖ , \qquad [ Equation 6 ]$$

as implant, after diffusion ⊂ HW

Referring to Equation 6, one example (operation S43) of substituting the approximation function Ĉ approximated by the neural network into the hardware data and calculating and/or determining, as Loss_{HW}(Ĉ), a difference value between the approximation function and the hardware data, but the example embodiments are not limited thereto.

According to at least one example embodiment, the second loss function Loss_{HW} may indicate how much the approximation function Loss_{HW} deviates from the hardware data.

$$Loss = {Loss}_{PDE} + {Loss}_{HW} \qquad [ Equation 7 ]$$

Referring to Equation 7, a loss function Loss in FIG. 7A may be the same as a value obtained by adding the first loss function Loss_{PDE} to the second loss function Loss_{HW} in operation S50, but the example embodiments are not limited thereto.

Referring to FIGS. 7A and 7B, the parameter θ of a neural network function and the first and second parameters D₀ and E_{α} of the internal equation may be simultaneously learned using the loss function Loss, but the example embodiments are not limited thereto. According to at least one example embodiment, parameters may be learned using Equations 8, 9, and 10, but are not limited thereto.

$${D}_{0} = {D}_{0} - lr \frac{\partial Loss}{\partial {D}_{0}} \qquad [ Equation 8 ]$$

$${E}_{a} = {E}_{a} - lr \frac{\partial Loss}{\partial {E}_{a}} \qquad [ Equation 9 ]$$

$$θ = θ - lr \frac{\partial Loss}{\partial θ} \qquad [ Equation 10 ]$$

Equation 8 may be an equation for learning the first parameter D₀ of the internal equation. Equation 9 may be an equation for learning the second parameter E_{α} of the internal equation. Equation 10 may be an equation for learning the parameter θ of the neural network function.

According to at least one example embodiment, Equations 8, 9, and 10 may be equations to which a gradient descent algorithm is applied. In Equations 8, 9, and 10, Loss denotes the loss function and lr denotes a learning rate. The learning rate lr may be a pre-defined value or a variable value. By learning the first parameter D₀ satisfying Equation 8, the first parameter D₀ by which the loss function Loss satisfies 0 may be calibrated. By learning the second parameter E_{α} satisfying Equation 9, the second parameter E_{α} by which the loss function Loss satisfies 0 may be calibrated. By learning the parameter θ of the neural network function satisfying Equation 10, the parameter θ of the neural network function by which the loss function Loss satisfies 0 may be calibrated.

Referring to operation S41 of FIG. 7C, the first parameter D₀ and the second parameter E_{α} may be set to a vector form (\vec{D}0, \vec{E}α). By doing this, several solutions of the first parameter D₀ and the second parameter E_{α} may be found out at once.

$$\begin{matrix}{\vec{D}}_{0} = [ {D}_{0 , 0} , {D}_{0 , 1} , … , {D}_{0 , n} ] , {\vec{E}}_{a} = [ {E}_{a , 0} , {E}_{a , 1} , … , {E}_{a , n} ] \\ {D}_{0 , 1} = {D}_{0 , 1} - lr \frac{\partial Loss}{\partial {D}_{0 , 1}} , {E}_{a , 1} = {E}_{a , 1} - lr \frac{\partial Loss}{\partial {E}_{a , 1}} \\ {D}_{0 , 2} = {D}_{0 , 2} - lr \frac{\partial Loss}{\partial {D}_{0 , 2}} , {E}_{a , 2} = {E}_{a , 2} - lr \frac{\partial Loss}{\partial {E}_{a , 2}} \\ ⋮ \\ {D}_{0 , n} = {D}_{0 , n} - lr \frac{\partial Loss}{\partial {D}_{0 , n}} , {E}_{a , n} = {E}_{a , n} - lr \frac{\partial Loss}{\partial {E}_{a , n}}\end{matrix} \qquad [ Equation 11 ]$$

Referring to Equation 11, a plurality of solutions \vec{D}₀=[D_{0,0}, D_{0,1}, . . . , D_{0,n}] of the first parameter \vec{D}₀=[D_{0,0}, D_{0,1}, . . . , D_{0,n}] and a plurality of solutions \vec{E}_{α}=[E_{α,0}, E_{α,1}, . . . , E_{a,n}] of the second parameter E_{α}=[E_{α,0}, E_{α,1}, . . . , E_{a,n}] corresponding thereto may be found out. Like Equations 8, 9, and 10, a gradient descent algorithm may be applied to Equation 11.

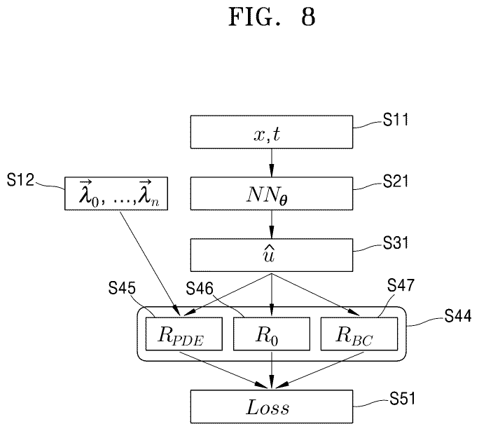

FIG. 8 is a flowchart illustrating an auto calibration method according to at least one example embodiment. According to at least one example embodiment, the at least one example embodiment of FIG. 8 may be an expanded example embodiment of the at least one example embodiment of FIGS. 7A to 7C.

Referring to FIG. 8, (x, t) may be input as input data in operation S11, but the example embodiments are not limited thereto. Once the input data (x, t) is input to an auto calibration system, an approximation function NN_{θ} based on the input data (x, t) may be generated in operation S21. θ included in the approximation function NN_{θ} may be at least one parameter included in the approximation function NN_{θ}. Referring to FIG. 8, output data obtained in operation S31 by the approximation function NN_{θ} may be represented by û.

$${u}_{t} = [ u ; {λ}_{0} , … , {λ}_{n} ] , x ∈ Ω , t ∈ [ 0 , T ] \qquad [ Equation 12 ]$$

$$B [ u ] = 0 , x ∈ \partial Ω , t ∈ [ 0 , T ] \qquad [ Equation 13 ]$$

$$u ( x , 0 ) = {u}_{0} , x ∈ Ω , t = 0 \qquad [ Equation 14 ]$$

$$u ( x , T ) = {u}_{T} , x ∈ Ω , t = T \qquad [ Equation 15 ]$$

According to at least one example embodiment of the inventive concepts, a network configured to adjust, improve, and/or optimize the approximation function NN_{θ} capable of satisfying hardware data (e.g., design requirements, user requirements, etc.) may be constructed using a deep neural network model, at least one internal equation, and at least one parameter of the internal equation. Equation 12 may be an example of a PDE included in a TCAD simulator as an example. In Equation 12, uₜ denotes a function obtained by partially differentiating a function u(x,t) with respect to t, and N[u; λ₀, . . . , λₙ] denotes a partial differential function with respect to u(x,t) including parameters λ₀, . . . , λₙ. The left side of Equation 12 may correspond to the left side of the internal equation of FIG. 7A, and the right side of Equation 12 may correspond to the right side of the internal equation of FIG. 7A. However, Equation 12 is not limited to the internal equation of FIG. 7A.

Equation 13 may be a function of a boundary condition related to Equation 12, but the example embodiments are not limited thereto. B[u] may be a function indicating a boundary condition of u(x,t).

Equations 14 and 15 may indicate hardware data under an initial condition and hardware data as the final result after the total time elapses, respectively, but are not limited thereto.

The approximation function NNθ may be generated based on Equations 12, 13, 14, and 15. The approximation function NNθ may be generated by Equation 16.

$${NN}_{θ} : ( x , t ) \to \hat{u} \qquad [ Equation 16 ]$$

According to at least one example embodiment, initialization may be performed by configuring the parameter θ included in a deep neural network and the parameters λ₀, . . . , λₙ of the internal equation as learning parameters. According to at least one example embodiment, the approximation function NN_{θ} may be adjusted, improved, and/or optimized by transforming the internal equation into a learnable objective function. Once the approximation function NN_{θ} is determined, a loss function may be calculated and/or determined based on the approximation function NN_{θ}.

$${R}_{PDE} = \frac{1}{{N}_{PDE}} {\sum }_{i}^{{N}_{PDE}} {( {\hat{u}}_{t} - [ u ; {λ}_{0} , … , {λ}_{n} ] )}^{2} \qquad [ Equation 17 ]$$

$${R}_{BC} = \frac{1}{{N}_{BC}} {\sum }_{i}^{{N}_{BC}} {B [ \hat{u} ]}^{2} \qquad [ Equation 18 ]$$

$${R}_{0} = \frac{1}{{N}_{0}} {\sum }_{i}^{{N}_{0}} {( \hat{u} ( x , 0 ) - {u}_{0} )}^{2} + \frac{1}{{N}_{T}} {\sum }_{i}^{{N}_{T}} {( \hat{u} ( x , T ) - {u}_{T} )}^{2} \qquad [ Equation 19 ]$$

Equation 17 may be an example of a first loss function obtained by substituting the approximation function NN_{θ} into the internal equation and calculating and/or determining the difference between the approximation function NN_{θ} and the internal equation. Equation 18 may be an example of a third loss function obtained by substituting the approximation function NN_{θ} into the boundary condition and calculating and/or determining the substitution result. Equation 19 may be an example of a second loss function obtained by comparing the approximation function NN_{θ} to hardware data and calculating and/or determining the difference between the approximation function NN_{θ} and the hardware data. Learning may be performed using Equations 17, 18, and 19 such that the sum of the first loss function, the second loss function, and the third loss function is 0, but the example embodiments are not limited thereto.

According to at least one example embodiment, the parameter θ included in the deep neural network may be adjusted, improved, and/or optimized by fixing the parameters λ₀, . . . , λₙ of the internal equation and then adjusting, improving, and/or optimizing the approximation function NN_{θ} approximated through the deep neural network such that the approximation function NN_{θ} approximates the internal equation. Thereafter, the parameters λ₀, . . . , λₙ of the internal equation and the parameter θ included in the deep neural network may be simultaneously adjusted, improved and/or optimized to approximate the internal equation and the hardware data. Herein, the parameters λ₀, . . . , A, of the internal equation may be constructed in a vector form such that several solutions are adjusted, improved and/or optimized at once.

According to at least one example embodiment of the inventive concepts, a calibrated TCAD environment may be constructed by directly applying the adjusted, improved and/or optimized several parameters λ₀, . . . , λₙ of a PDE to a TCAD without post-processing. According to at least one example embodiment of the inventive concepts, because an equation based on an approximation function, internal equations, and hardware data is used, a TCAD environment may be constructed without TCAD data.

According to at least one example embodiment of the inventive concepts, at least one parameter of an internal equation may be adjusted, improved and/or optimized by using a user-defined equation, e.g., the internal equation, as an input, etc., but the example embodiments are not limited thereto.

In addition, according to at least one example embodiment of the inventive concepts, because solution finding and a calibration are simultaneously performed, a non-calibrated intermediate result may not exist. According to the comparative examples, because solution finding and a calibration cannot be simultaneously performed, iterative simulations are necessary, and non-calibrated TCAD intermediate results are necessarily generated.

In addition, according to at least one example embodiment of the inventive concepts, a TCAD license is not desired and/or required thereby reducing expenses, and a calibration may be performed by directly solving an equation based on a deep neural network.

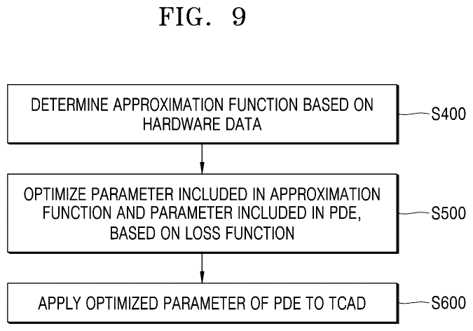

FIG. 9 is a detailed flowchart illustrating an auto calibration method according to at least one example embodiment.

In operation S400 of FIG. 9, an approximation function based on hardware data may be determined. According to at least one example embodiment of the inventive concepts, an approximation function using a deep neural network may be generated based on hardware data to satisfy the hardware data (and/or design requirements, user requirements, etc.). In a process of generating the approximation function, an internal equation, e.g., a PDE, at least one parameter of the internal equation, and the like, may be used, the parameter(s) being determined by a random number, but the example embodiments are not limited thereto.

In operation S500 of FIG. 9, at least one parameter included in the approximation function and at least one parameter included in a PDE may be adjusted, improved, and/or optimized based on a loss function. The PDE may indicate an internal equation input to an auto calibration system. In operation S500, the parameter(s) included in the PDE may be learned such that the loss function is 0, and a deep neural network approximating the approximation function may be trained. The parameters may be simultaneously learned and derived as a plurality of solutions at once.

In operation S600 of FIG. 9, the adjusted, improved, and/or optimized parameters of the PDE may be applied to a TCAD. Accordingly, a TCAD environment may be adjusted, improved, and/or optimized even without TCAD data.

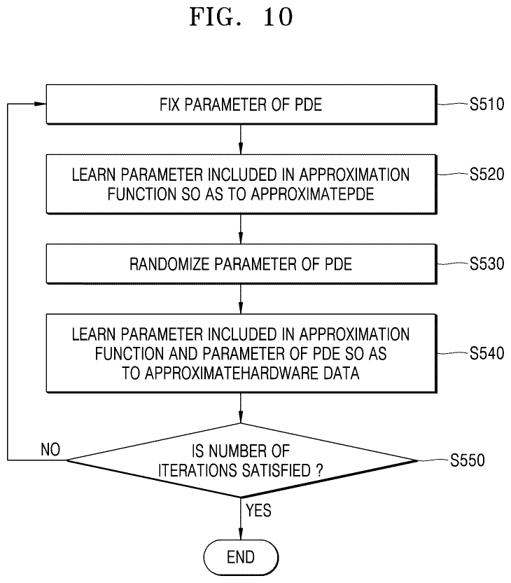

FIG. 10 is a detailed flowchart illustrating an auto calibration method according to at least one example embodiment.

According to at least one example embodiment, operations S510 to S550 of FIG. 10 may be included in operation S500 of FIG. 9, but are not limited thereto.

In operation S510 of FIG. 10, at least one parameter of a PDE may be fixed. In a situation in which a plurality of parameters are adjusted, improved, and/or optimized, the parameter(s) of the PDE may be primarily fixed to a random number, but are not limited thereto.

In operation S520 of FIG. 10, at least one parameter included in an approximation function may be learned to approximate the PDE of operation S510. In operation S520, the parameter(s) included in the approximation function may be learned in a state in which the fixed parameter of the PDE is reflected.

In operation S530 of FIG. 10, the parameter(s) of the PDE may be randomized. In operation S530, to adjust, improve, and/or optimize the parameter of the PDE, the parameter may be randomized and learned.

In operation S540 of FIG. 10, the parameter(s) included in the approximation function and the parameter(s) of the PDE may be learned to approximate hardware data. In operation S540, a plurality of parameters may be learned to satisfy both the hardware data (e.g., design requirements, user requirements, etc.) and the PDE, but the example embodiments are not limited thereto.

In operation S550 of FIG. 10, it may be determined whether a desired and/or pre-defined number of iterations of the auto calibration method has been satisfied. If the learning is performed by the desired and/or pre-defined number of iterations, the learning ends, and if the learning is not performed by the desired and/or pre-defined number of iterations, the learning may be performed again. The desired and/or pre-defined number of iterations may be determined by the auto calibration system, may be set by a user, etc.

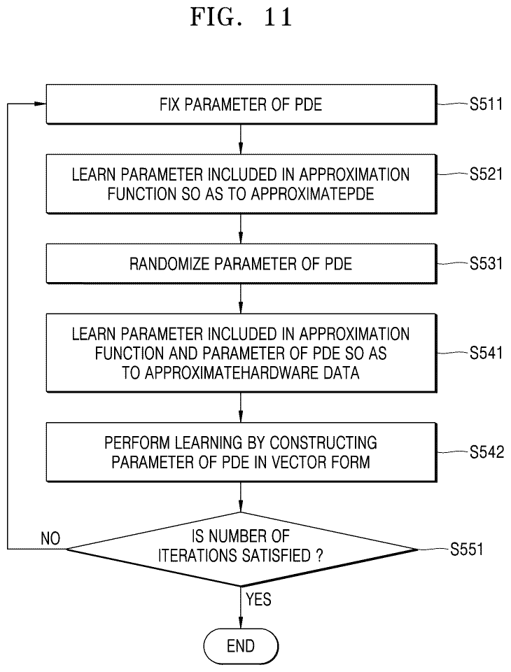

FIG. 11 is a detailed flowchart illustrating an auto calibration method according to at least one example embodiment.

According to at least one example embodiment, operations S511 to S551 of FIG. 11 may be included in operation S500 of FIG. 9.

Operation S511 of FIG. 11 may correspond to operation S510 of FIG. 10, but the example embodiments are not limited thereto. Operation S521 of FIG. 11 may correspond to operation S520 of FIG. 10, but the example embodiments are not limited thereto. Operation S531 of FIG. 11 may correspond to operation S530 of FIG. 10, but the example embodiments are not limited thereto. Operation S541 of FIG. 11 may correspond to operation S540 of FIG. 10, but the example embodiments are not limited thereto. Operation S551 of FIG. 11 may correspond to operation S550 of FIG. 10, but the example embodiments are not limited thereto.

Referring to FIG. 11, in operation S542, at least one parameter of a PDE may be constructed and/or generated in a vector form and learned. By doing this, a plurality of pairs of solutions of the parameter of the PDE may be obtained.

FIG. 12 is a block diagram illustrating a computer system 160 according to at least one example embodiment.

In some example embodiments, the computer system 160 of FIG. 12 may train learning models used in the auto calibration methods described above and may be referred to as an auto calibration system, but the example embodiments are not limited thereto, and other computer systems may be used to execute the auto calibration methods of one or more of the example embodiments.

The computer system 160 may be referred to as a computer system including a general-purpose executing special-purpose computer readable instructions implementing at least one example embodiment of the auto calibration method discussed herein, a special-purpose computing system including special-purpose hardware for executing at least one example embodiment of the auto calibration method discussed herein, or any combinations thereof. For example, the computer system 160 may include a personal computer, a server computer, a laptop computer, a home appliance, or the like. As shown in FIG. 12, the computer system 160 may include at least one processor 161, a memory 162, a storage system 163, a network adapter 164, an input/output interface 165, and/or a display 166, etc., but is not limited thereto.

The at least one processor 161 may execute a program module including special-purpose computer system-executable instructions for implementing one or more aspects of the method(s) of at least one example embodiment.

For example, the program module may include routines, programs, objects, components, a logic, a data structure, or the like, configured to perform a particular task and/or implement a particular abstract data type associated with one or more operations of one or more of the methods discussed above. The memory 162 may include a computer system-readable medium of a volatile memory type, such as random access memory (RAM). The at least one processor 161 may access the memory 162 and execute computer readable instructions loaded on the memory 162. The storage system 163 may store information in a nonvolatile manner and may include at least one program product including a program module configured to train and adjust, improve, and/or optimize learning models for one or more of the auto calibration methods described above. A program may include, as a non-limiting example, an operating system, at least one application, other program modules, and/or program data, etc.

The network adapter 164 may provide a connection to a local area network (LAN), a wide area network (WAN), a public network (e.g., the Internet), and/or the like. The input/output interface 165 may provide a communication channel with a peripheral device, such as a keyboard, a pointing device, and/or an audio system. The display 166 may output various pieces of information such that a user identifies the information.

In some example embodiments, training of learning models for the auto calibration methods described above may be implemented by a special-purpose computer program product. The special-purpose computer program product may include a non-transitory computer-readable medium (e.g., a storage medium, etc.) containing computer-readable instructions allowing the at least one processor 161 to process an image and/or train models according to at least one example embodiment. The computer-readable instructions may be, as a non-limiting example, assembler instructions, instruction set architecture (ISA) instructions, machine instructions, machine-dependent instructions, micro code, firmware instructions, state configuration data, and/or source code or object code edited using at least one programing language, etc.

The non-transitory computer-readable medium may be a type of memory medium capable of non-transitorily holding and storing instructions to be executed by the at least one processor 161 and/or an instruction-executable device, but is not limited thereto. The non-transitory computer-readable medium may be an electronic storage device, a magnetic storage device, an optical storage device, an electromagnetic storage device, a semiconductor storage device, or a combination thereof but is not limited thereto. For example, the non-transitory computer-readable medium may be a portable computer diskette, a hard disk, RAM, read-only memory (ROM), electrically erasable read-only memory (EEPROM), flash memory, static random access memory (SRAM), a compact disc (CD), a digital versatile disc (DVD), a memory stick, a floppy disk, a mechanically encoded device, such as a punch card, or a combination thereof.

While various example embodiments of the inventive concepts have been particularly shown and described, it will be understood that various changes in form and details may be made therein without departing from the spirit and scope of the following claims.

What is claimed is:

1. An auto calibration method comprising:
receiving at least one internal equation, input data associated with a semiconductor device design, and hardware data associated with the semiconductor device design;
generating at least one approximation function based on the input data and the hardware data;
determining at least one loss function based on the generated at least one approximation function;
determining at least one parameter of the at least one approximation function and at least one parameter of the at least one internal equation such that a value of the loss function is 0; and
selectively adjusting the semiconductor device design based on the determined at least one parameter of the at least one approximation function and the at least one parameter of the at least one internal equation.

2. The auto calibration method of claim 1, wherein the at least one internal equation includes a partial differential equation (PDE).

3. The auto calibration method of claim 1, wherein the determining the at least one loss function based on the generated at least one approximation function further comprises:
determining a first loss function by applying the at least one approximation function to the at least one internal equation.

4. The auto calibration method of claim 1, wherein the determining the at least one loss function based on the generated at least one approximation function further comprises:
determining a second loss function by comparing the at least one approximation function to the hardware data.

5. The auto calibration method of claim 1, wherein the determining the at least one loss function based on the generated at least one approximation function further comprises:
determining a third loss function by comparing the at least one approximation function to at least one boundary condition of the at least one internal equation.

6. The auto calibration method of claim 1, wherein the determining the at least one parameter of the at least one approximation function and the at least one parameter of the at least one internal equation further comprises:
determining the at least one loss function based on a gradient descent algorithm.

7. The auto calibration method of claim 6, wherein the determining the at least one parameter of the at least one approximation function and the at least one parameter of the at least one internal equation further comprises:
simultaneously determining the at least one parameter of the at least one approximation function and the at least one parameter of the at least one internal equation.

8. The auto calibration method of claim 6, wherein the determining the at least one parameter of the at least one approximation function and the at least one parameter of the at least one internal equation further comprises:
configuring the at least one parameter of the at least one internal equation in a vector form to determine a plurality of solutions of the at least one parameter of the at least one internal equation.

9. The auto calibration method of claim 1, wherein the determining the at least one parameter of the at least one approximation function and the at least one parameter of the at least one internal equation further comprises:
fixing the at least one parameter of the at least one internal equation to determine the parameter included in the at least one approximation function; and
randomizing the at least one parameter of the at least one internal equation to determine the at least one parameter included in the at least one approximation function and the at least one parameter of the at least one internal equation.

10. The auto calibration method of claim 9, wherein
the fixing of the at least one parameter of the at least one internal equation further comprises,
performing the determining the at least one parameter included in the at least one approximation function such that the at least one parameter included in the at least one approximation function approximates the at least one internal equation; and
the randomizing of the at least one parameter of the at least one internal equation to determine the at least one parameter included in the at least one approximation function and the at least one parameter of the at least one approximation function further comprises,
determining the at least one parameter included in the at least one approximation function and the at least one parameter of the at least one internal equation so as to approximate the hardware data.

11. A system comprising:
non-transitory storage medium storing computer readable instructions; and
processing circuitry configured to execute the computer readable instructions to perform the auto calibration method of claim 1.

12. A non-transitory computer-readable storage medium storing computer readable instructions, which when executed by processing circuitry, causes the processing circuitry to:
receive at least one internal equation, input data associated with a semiconductor device design, and hardware data associated with the semiconductor device design;
generate at least one approximation function based on the input data and the hardware data;
determine at least one loss function based on the generated at least one approximation function;
determine at least one parameter of the at least one approximation function and at least one parameter of the at least one internal equation such that a value of the loss function is 0; and
selectively adjust the semiconductor device design based on the determined at least one parameter of the at least one approximation function and the at least one parameter of the at least one internal equation.

13. An auto calibration system comprising:
processing circuitry configured to,
receive at least one internal equation associated with a semiconductor device design and hardware data associated with the semiconductor device design as inputs;
generate at least one approximation function based on the hardware data;
generate at least one loss function based on the at least one approximation function;
determine at least one parameter of the at least one approximation function and at least one parameter of the at least one internal equation such that the generated at least one loss function is 0; and
selectively adjust the semiconductor device design based on the determined at least one parameter of the at least one approximation function and the at least one parameter of the at least one internal equation.

14. The auto calibration system of claim 13, wherein the processing circuitry is further configured to:
generate the at least one approximation function using a deep learning network such that the hardware data is satisfied.

15. The auto calibration system of claim 13, wherein the processing circuitry is further configured to:
generate the at least one loss function based on the at least one approximation function; and
simultaneously learn the at least one parameter of the at least one approximation function and the at least one parameter of the at least one internal equation such that output of the at least one loss function is 0.

16. The auto calibration system of claim 15, wherein the processing circuitry is further configured to:
output each of a first loss function determined by applying the at least one approximation function to the at least one internal equation, a second loss function determined by comparing the at least one approximation function to the hardware data, and a third loss function determined by comparing the at least one approximation function to at least one boundary condition of the at least one internal equation.

17. The auto calibration system of claim 16, wherein the processing circuitry is further configured to:
determine the at least one parameter of the at least one approximation function and the at least one parameter of the at least one internal equation such that a sum of the first loss function, the second loss function, and the third loss function is 0.

18. The auto calibration system of claim 15, wherein the processing circuitry is further configured to:
determine the at least one loss function based on a gradient descent algorithm.

19. The auto calibration system of claim 15, wherein the processing circuitry is further configured to:
configure the at least one parameter of the at least one internal equation in a vector form to determine a plurality of solutions of the at least one parameter of the at least one internal equation.

20. The auto calibration system of claim 15, wherein the processing circuitry is further configured to:
fix the at least one parameter of the at least one internal equation to determine the at least one parameter included in the at least one approximation function; and
randomize the at least one parameter of the at least one internal equation to determine the at least one parameter included in the at least one approximation function and the at least one parameter of the at least one internal equation.
